(19) United States
(12) Patent Application Publication
(10) Pub. No.: US 2026/0342525 A1
(43) Pub. Date: Oct. 29, 2026

(54) CHANNEL ESTIMATION TECHNIQUES FOR MIXED-LENGTH ORTHOGONAL COVER CODES

(71) Applicant: QUALCOMM Incorporated, San Diego, CA (US)

(72) Inventors: Chih-Hao LIU, San Diego, CA (US); Jing SUN, San Diego, CA (US); Jing LEI, San Diego, CA (US); Yu ZHANG, San Diego, CA (US)

(21) Appl. No.: 19/192,070

(22) Filed: Apr. 28, 2025

(51) Int. Cl. H04L 5/00; H04L 25/02; H04W 72/231

(52) U.S. Cl. CPC H04L 5/0094; H04L 5/0026; H04L 25/0204; H04W 72/231

(57) ABSTRACT

This disclosure provides methods, components, devices, and systems for channel estimation techniques for mixed length OCCs. For example, a receiving device such as a user equipment (UE) may receive control signaling that indicates, for a codebook that includes a set of first OCCs of a first length (such as length-4 OCCs), a first subset of the first OCCs that correspond to a first subset of one or more transmission layers that are to be decoded by the UE using one or more second OCCs of a second, shorter length (such as length-2 OCC). The UE may decode (e.g., de-OCC) the first subset of one or more transmission layers using the one or more second OCCs having the second length and decode (e.g., de-OCC) a remaining subset of one or more transmission layers using a second subset one or more first OCCs having the first length.

### TECHNICAL FIELD

This disclosure relates generally to wireless communication, and more specifically to systems, devices, methods, and techniques associated with channel estimation techniques for mixed length orthogonal cover codes (OCCs).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. In some cases, a system may support different length orthogonal cover coding (OCC) sequences, such as length-2 OCC sequences (e.g., OCC 2 sequences) and length-4 OCC sequences (e.g., OCC 4 sequences), to encode different transmission layers of a wireless channel. Some different OCC lengths may yield higher performance based on various conditions of the applied channel. For example, OCC 4 sequences may be more effectively applied to channels having a flatter frequency response, while OCC 2 sequences may be applied to more frequency selective channels In some cases, however, a user equipment (UE) may be configured to decode (e.g., de-OCC) and perform channel estimation for multiple layers of a transmission channel using a mixed de-OCC scheme, where the UE is able to use both OCC 2 and OCC 4 for decoding the channel.

To support decoding and channel estimation using different length OCCs, the UE may be configured with a subset of an OCC codebook of a first length (e.g., an OCC 4) that can be decoded (e.g., de-OCC) using shorter length OCCs (e.g., OCC 2). In some examples, the UE may assign transmission layers that have a relatively low frequency domain correlation (e.g., a less flat frequency response, or a frequency domain correlation that is below a threshold frequency domain correlation) to the subset of the OCC codebook that can be decoded using the shorter length OCC codes (e.g., de-OCC 2), and may assign transmission layers that have a relatively high frequency domain correlation (e.g., a relatively flat frequency channel or a frequency domain correlation that meets or exceeds the frequency domain correlation threshold) as being layers that are to be decoded using the longer length OCC codes (e.g., de-OCC 4). The following is a summary of some non-limiting aspects of the disclosure:

A method for wireless communications by a UE is described. The method may include receiving control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded by the UE using one or more second OCCs of a second length, the second length shorter than the first length and decoding, in accordance with the control signaling, the first subset of one or more transmission layers using the one or more second OCCs of the second length and a second subset of one or more transmission layers from the set of multiple transmission layers using a second subset of one or more first OCCs from the set of first OCCs of the first length.

A UE for wireless communications is described. The UE may include a processing system that includes processor circuitry and memory circuitry that stores code. The processing system may be configured to cause the UE to receive control signaling that indicates, for a codebook associated with a set of multiple transmission layers and including a set of OCCs of a first length, a first subset of one or more first OCCs from the set of first OCCs that correspond to a first subset of one or more transmission layers from the set of multiple transmission layers that are to be decoded by the UE using one or more second OCCs of a second length, the second length shorter than the first length and decode, in accordance with the control signaling, the first subset of one or more transmission layers using the one or more second OCCs of the second length and a second subset of one or more transmission layers from the set of multiple transmission layers using a second subset of one or more first OCCs from the set of first OCCs of the first length.

Another UE for wireless communications is described. The UE may include means for receiving control signaling that indicates, for a codebook associated with a set of multiple transmission layers and including a set of OCCs of a first length, a first subset of one or more first OCCs from the set of first OCCs that correspond to a first subset of one or more transmission layers from the set of multiple transmission layers that are to be decoded by the UE using one or more second OCCs of a second length, the second length shorter than the first length and means for decoding, in accordance with the control signaling, the first subset of one or more transmission layers using the one or more second OCCs of the second length and a second subset of one or more transmission layers from the set of multiple transmission layers using a second subset of one or more first OCCs from the set of first OCCs of the first length.

A non-transitory computer-readable medium storing code for wireless communications is described. The code may include instructions executable by one or more processors to receive control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded by the UE using one or more second OCCs of a second length, the second length shorter than the first length and decode, in accordance with the control signaling, the first subset of one or more transmission layers using the one or more second OCCs of the second length and a second subset of one or more transmission layers from the set of multiple transmission layers using a second subset of one or more first OCCs from the set of first OCCs of the first length.

In some examples of the method, UEs, and non-transitory computer-readable medium described herein, each of the one or more second OCCs of the second length may be orthogonal to each other of the one or more second OCCs of the second length.

In some examples of the method, UEs, and non-transitory computer-readable medium described herein, each of the one or more second OCCs of the second length includes a portion of a respective first OCC from the set of first OCCs of the first length.

In some examples of the method, UEs, and non-transitory computer-readable medium described herein, each OCC of the first subset of one or more first OCCs corresponds to a respective transmission layer in the first subset of one or more transmission layers, and each transmission layer in the first subset of one or more transmission layers may have a frequency domain correlation that may be less than a frequency domain correlation threshold.

In some examples of the method, UEs, and non-transitory computer-readable medium described herein, in accordance with the set of multiple transmission layers being assigned to respective OCCs from the set of first OCCs in accordance with respective frequency domain correlations: a first transmission layer having a lowest frequency domain correlation from among the set of multiple transmission layers may be assigned to a first OCC that may be decoded using a second OCC of the second length, and a second transmission layer having a highest frequency domain correlation from among the set of multiple transmission layers may be assigned to a different first OCC that may be decoded using a first OCC of the first length.

In some examples of the method, UEs, and non-transitory computer-readable medium described herein, the one or more transmission layers include four transmission layers and the first subset of the one or more transmission layers includes two transmission layers, and decoding the first subset of one or more transmission layers using the one or more second OCCs may include operations, features, means, or instructions for decoding each of the two transmission layers using respective second OCCs from among the one or more second OCCs, where a respective second OCC for a first one of the two transmission layers may be orthogonal to a respective second OCC for a second one of the two transmission layers.

In some examples of the method, UEs, and non-transitory computer-readable medium described herein, the one or more transmission layers include three transmission layers and the first subset of one or more transmission layers include a single transmission layer, and decoding the first subset of one or more transmission layers using the one or more second OCCs may include operations, features, means, or instructions for decoding the single transmission layer using a second OCC from among the one or more second OCCs.

In some examples of the method, UEs, and non-transitory computer-readable medium described herein, the one or more transmission layers are in accordance with single-user multiple-input multiple-output (SU-MIMO) communications, and receiving the control signaling may include operations, features, means, or instructions for receiving one or more radio resource control (RRC) messages that configure the first subset of one or more first OCCs that correspond to the first subset of one or more transmission layers that may be decoded by the UE using the one or more second OCCs of the second length.

In some examples of the method, UEs, and non-transitory computer-readable medium described herein, the one or more transmission layers are in accordance with multi-user multiple-input multiple-output (MU-MIMO) communications, and receiving the control signaling may include operations, features, means, or instructions for receiving a medium access control-control element (MAC-CE), downlink control information (DCI), or both, that indicates the first subset of one or more first OCCs that correspond to the first subset of one or more transmission layers that may be decoded by the UE using the one or more second OCCs of the second length.

Some examples of the method, UEs, and non-transitory computer-readable medium described herein may further include operations, features, means, or instructions for performing one or more first channel estimations for the first subset of one or more transmission layers that correspond to the one or more second OCCs of the second length and performing one or more second channel estimations for the second subset of one or more transmission layers that correspond to the one or more first OCCs of the first length.

In some examples of the method, UEs, and non-transitory computer-readable medium described herein, the one or more first channel estimations may be performed prior to the one or more second channel estimations, or the one or more first channel estimations may be performed subsequent to the one or more second channel estimations.

In some examples of the method, UEs, and non-transitory computer-readable medium described herein, the one or more first channel estimations may be performed simultaneously for all transmission layers in the first subset of one or more transmission layers or may be performed sequentially layer-by-layer for the transmission layers in the first subset of one or more transmission layers, and the one or more second channel estimations may be performed simultaneously on all transmission layers in the second subset of one or more transmission layers or may be performed sequentially layer-by-layer for the transmission layers in the second subset of one or more transmission layers.

Some examples of the method, UEs, and non-transitory computer-readable medium described herein may further include operations, features, means, or instructions for cancelling, prior to performing the one or more second channel estimations, one or more signal components associated with the first subset of one or more transmission layers from a received signal that corresponds to the second subset of one or more transmission layers.

Some examples of the method, UEs, and non-transitory computer-readable medium described herein may further include operations, features, means, or instructions for cancelling, prior to performing the one or more first channel estimations, one or more signal components associated with the second subset of one or more transmission layers from a received signal that corresponds the first subset of one or more transmission layers.

A method for wireless communications by a network entity is described. The method may include outputting control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded using one or more second OCCs of a second length, the second length shorter than the first length and outputting, in accordance with the control signaling via a multi-layer transmission, the first subset of one or more transmission layers that are to be decoded using the one or more second OCCs of the second length and a second subset of one or more transmission layers from the set of multiple transmission layers that are to be decoded using a second subset of one or more first OCCs from the set of first OCCs of the first length.

A network entity for wireless communications is described. The network entity may include a processing system that includes processor circuitry and memory circuitry that stores code. The processing system may be configured to cause the network entity to output control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded using one or more second OCCs of a second length, the second length shorter than the first length and output, in accordance with the control signaling via a multi-layer transmission, the first subset of one or more transmission layers that are to be decoded using the one or more second OCCs of the second length and a second subset of one or more transmission layers from the set of multiple transmission layers that are to be decoded using a second subset of one or more first OCCs from the set of first OCCs of the first length.

Another network entity for wireless communications is described. The network entity may include means for outputting control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded using one or more second OCCs of a second length, the second length shorter than the first length and means for outputting, in accordance with the control signaling via a multi-layer transmission, the first subset of one or more transmission layers that are to be decoded using the one or more second OCCs of the second length and a second subset of one or more transmission layers from the set of multiple transmission layers that are to be decoded using a second subset of one or more first OCCs from the set of first OCCs of the first length.

A non-transitory computer-readable medium storing code for wireless communications is described. The code may include instructions executable by one or more processors to output control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded using one or more second OCCs of a second length, the second length shorter than the first length and output, in accordance with the control signaling via a multi-layer transmission, the first subset of one or more transmission layers that are to be decoded using the one or more second OCCs of the second length and a second subset of one or more transmission layers from the set of multiple transmission layers that are to be decoded using a second subset of one or more first OCCs from the set of first OCCs of the first length.

In some examples of the method, network entities, and non-transitory computer-readable medium described herein, each of the one or more second OCCs of the second length may be orthogonal to each other of the one or more second OCCs of the second length.

In some examples of the method, network entities, and non-transitory computer-readable medium described herein, each of the one or more second OCCs of the second length includes a portion of a respective first OCC from the set of first OCCs of the first length.

In some examples of the method, network entities, and non-transitory computer-readable medium described herein, each OCC of the first subset of one or more first OCCs corresponds to a respective transmission layer in the first subset of one or more transmission layers, and each transmission layer in the first subset of one or more transmission layers may have a frequency domain correlation that may be less than a frequency domain correlation threshold.

In some examples of the method, network entities, and non-transitory computer-readable medium described herein, in accordance with the set of multiple transmission layers being assigned to respective OCCs from the set of first OCCs in accordance with respective frequency domain correlations: a first transmission layer having a lowest frequency domain correlation from among the set of multiple transmission layers may be assigned to a first OCC that may be decoded using a second OCC of the second length, and a second transmission layer having a highest frequency domain correlation from among the set of multiple transmission layers may be assigned to a different first OCC that may be decoded using a first OCC of the first length.

In some examples of the method, network entities, and non-transitory computer-readable medium described herein, the set of multiple transmission layers includes four transmission layers and the first subset of one or more transmission layers includes two transmission layers, each of the two transmission layers may be decoded using respective second OCCs from among the one or more second OCCs, and a respective second OCC for a first one of the two transmission layers may be orthogonal to a respective second OCC for a second one of the two transmission layers.

In some examples of the method, network entities, and non-transitory computer-readable medium described herein, the set of multiple transmission layers includes three transmission layers and the first subset of one or more transmission layers includes a single transmission layer and the single transmission layer may be decoded using a second OCC from among the one or more second OCCs.

In some examples of the method, network entities, and non-transitory computer-readable medium described herein, the set of multiple transmission layers may be in accordance with SU-MIMO communications, and outputting the control signaling may include operations, features, means, or instructions for outputting one or more RRC messages that configure the first subset of one or more first OCCs that correspond to the first subset of one or more transmission layers that may be decoded using the one or more second OCCs of the second length.

In some examples of the method, network entities, and non-transitory computer-readable medium described herein, the set of multiple transmission layers may be in accordance with MU-MIMO communications, and outputting the control signaling may include operations, features, means, or instructions for outputting a MAC-CE, DCI, or both, that indicates the first subset of one or more first OCCs that correspond to the first subset of one or more transmission layers that may be decoded using the one or more second OCCs of the second length.

### BRIEF DESCRIPTION OF THE DRAWINGS

FIG. 1 shows an example of a wireless communication system.

FIGS. 2 and 3 each show an example of a signaling configuration that supports channel estimation techniques for mixed-length orthogonal cover codes (OCCs).

FIG. 4 shows an example of a channel estimation scheme that supports channel estimation techniques for mixed length OCCs.

FIG. 5 shows an example of a process flow that supports channel estimation techniques for mixed length OCCs.

FIG. 6 shows a block diagram of a processing system that supports channel estimation techniques for mixed length OCCs.

FIG. 7 shows a diagram of a system including a device that supports channel estimation techniques for mixed length OCCs.

FIG. 8 shows a block diagram of a processing system that supports channel estimation techniques for mixed length OCCs.

FIG. 9 shows a diagram of a system including a device that supports channel estimation techniques for mixed length OCCs.

FIGS. 10 and 11 show flowcharts illustrating methods that support channel estimation techniques for mixed length OCCs.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a transmission entity (such as a network entity) may transmit pilot sequences, such as demodulation reference signals (DMRSs), that a user equipment (UE) may use for performing channel estimation and multiple-input multiple-output (MIMO) decoding and related demodulation. In some implementations, DMRSs corresponding to each data transmission layer may be mutually orthogonal. That is, DMRSs corresponding to each data transmission layer may be distinguished using frequency division multiplexing (FDM) and/or code division multiplexing (CDM), which may be implemented by spreading sequences such as orthogonal cover code (OCC) sequences. In some cases, a system may support different length OCC sequences, such as length-2 OCC sequences (e.g., OCC 2 sequences) and length-4 OCC sequences (e.g., OCC 4 sequences), to encode different transmission layers (e.g., MIMO layers) of a transmission channel.

Some different OCC lengths may yield higher performance based on various conditions of the applied channel. For example, OCC 4 sequences may be more effectively applied to channels having a flatter frequency response (e.g., channels with a frequency domain correlation below a threshold), while OCC 2 sequences may be applied to more frequency selective channels (e.g., channels with a less flat frequency response, or channels with a frequency domain correlation above a threshold). In some cases, however, a UE may be configured to decode (e.g., de-OCC) and perform channel estimation for multiple layers of a transmission channel using a mixed de-OCC scheme, where the UE is able to use both OCC 2 and OCC 4 for decoding the channel.

To support decoding and channel estimation using different length OCCs, the UE may be configured with a subset of an OCC codebook of a first length (e.g., an OCC 4) that can be decoded (e.g., de-OCC) using shorter length OCCs (e.g., OCC 2). In some examples, the UE may assign transmission layers that have a relatively low frequency domain correlation (e.g., a less flat frequency response, or a frequency domain correlation that is below a threshold frequency domain correlation) to the subset of the OCC codebook that can be decoded using the shorter length OCC codes (e.g., de-OCC 2), and may assign transmission layers that have a relatively high frequency domain correlation (e.g., a relatively flat frequency channel or a frequency domain correlation that meets or exceeds the frequency domain correlation threshold) as being layers that are to be decoded using the longer length OCC codes (e.g., de-OCC 4). In some examples, the network entity may transmit signaling (e.g., static or semi-static signaling such as radio resource control (RRC) signaling, or dynamic signaling such as downlink control information (DCI) or medium access control-control element (MAC-CE) signaling) to the UE which indicates the subset of the OCC codebook that can be decoded using shorter length OCC codes.

In some implementations, the UE may implement successive interference cancellation techniques to further support mixed OCC techniques. For example, the UE may perform channel estimation on a first subset of transmission layers using a first OCC group having a first length, and may cancel the estimated channel from the first OCC group from a received signal, and then may perform an additional channel estimation for the remaining subset of transmission layers using a second OCC group having the first length. In some cases, the DMRS power of the first subset of transmission layers may be power boosted in order to further increase channel estimation accuracy.

Particular aspects of the subject matter described in this disclosure can be implemented to realize one or more of the following potential advantages. In some examples, by configuring mixed OCC schemes, the described techniques can be used to increase channel estimation accuracy for different channel conditions while maintaining increased throughput associated with longer length OCC codes. For example, longer length OCCs may be applied for transmission layers having a relatively flatter frequency response, while shorter length OCCs may be applied for transmission layers having relatively less flat frequency responses (e.g., frequency selective channels), which may allow for both increased throughput (based on use of longer length OCC codes) and increased channel estimation accuracy (based on application of shorter length OCC codes to frequency selective channels, where longer length OCCs may be less suitable). Additionally, or alternatively, by supporting both dynamic, static, and/or semi-static assignment of different length OCCs to different layers, a wireless communications system may have more flexible control over increasing throughput, increasing channel estimation accuracy, or both. Additionally, or alternatively, the successive interference cancellation techniques described herein may further allow for improved channel estimation accuracy by reducing inter-layer interference between layers encoded using mixed-length OCCs. That is, by cancelling interference from a first length OCC from a signal prior to performing channel estimation for layers encoded using a second length OCC, the UE may obtain a more accurate channel estimation metric (that is less affected by inter-layer interference).

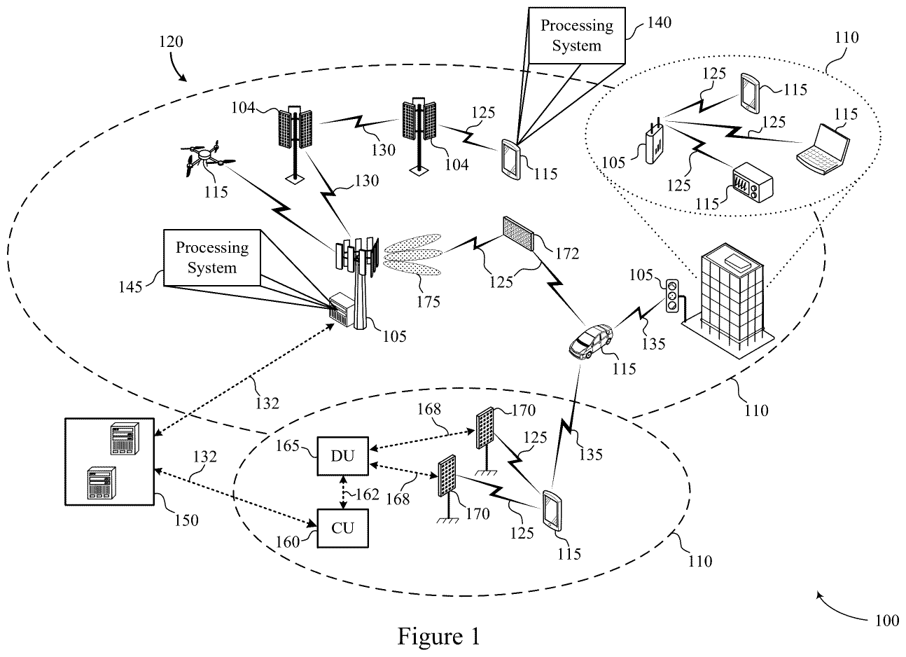

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A MAC layer may perform priority handling and multiplexing of logical channels into transport channels. A MAC layer also may implement error detection techniques, error correction techniques, or retransmissions. In a control plane, an RRC layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating DCI and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, DMRSs that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for channel estimation techniques for mixed-length OCCs. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support techniques for mixed OCC encoding and decoding as described herein. For example, the wireless communication system 100 may support different length OCC sequences, such as length-2 OCC sequences (e.g., OCC 2 sequences) and length-4 OCC sequences (e.g., OCC 4 sequences), to encode different transmission layers of a transmission channel.

In some implementations, OCC 4 sequences may be more effectively applied to channels having a flatter frequency response (e.g., channels with a frequency domain correlation below a threshold), while OCC 2 sequences may be applied to more frequency selective channels (e.g., channels with a less flat frequency response, or channels with a frequency domain correlation above a threshold). In some cases, however, a UE 115 may be configured to decode (e.g., de-OCC) and perform channel estimation for multiple layers of a transmission channel using a mixed de-OCC scheme, where the UE 115 is able to use both OCC 2 and OCC 4 for decoding the channel.

To support decoding and channel estimation using different length OCCs, the UE 115 may be configured with a subset of an OCC codebook of a first length (e.g., an OCC 4) that can be decoded (e.g., de-OCC) using shorter length OCCs (e.g., OCC 2). In some examples, the UE 115 may assign transmission layers that have a relatively low frequency domain correlation (e.g., a less flat frequency response, or a frequency domain correlation that is below a threshold frequency domain correlation) to the subset of the OCC codebook that can be decoded using the shorter length OCC codes (e.g., de-OCC 2), and may assign transmission layers that have a relatively high frequency domain correlation (e.g., a relatively flat frequency channel or a frequency domain correlation that meets or exceeds the frequency domain correlation threshold) as being layers that are to be decoded using the longer length OCC codes (e.g., de-OCC 4).

In some aspects, the implementation of mixed-length OCC may support improved throughput and channel estimation accuracy for the wireless communications system 10. For example, the use of longer length OCCs (such as OCC 4) may allow for multiplexing of a larger quantity of UEs on a single communication resource as opposed to shorter length OCCs alone. Additionally, or alternatively, the use of mixed OCC lengths may allow for improved channel estimation accuracy, because shorter length OCC codes may be applied to more frequency selective layers, while longer length OCC codes may be applied to layers with flatter frequency profiles.

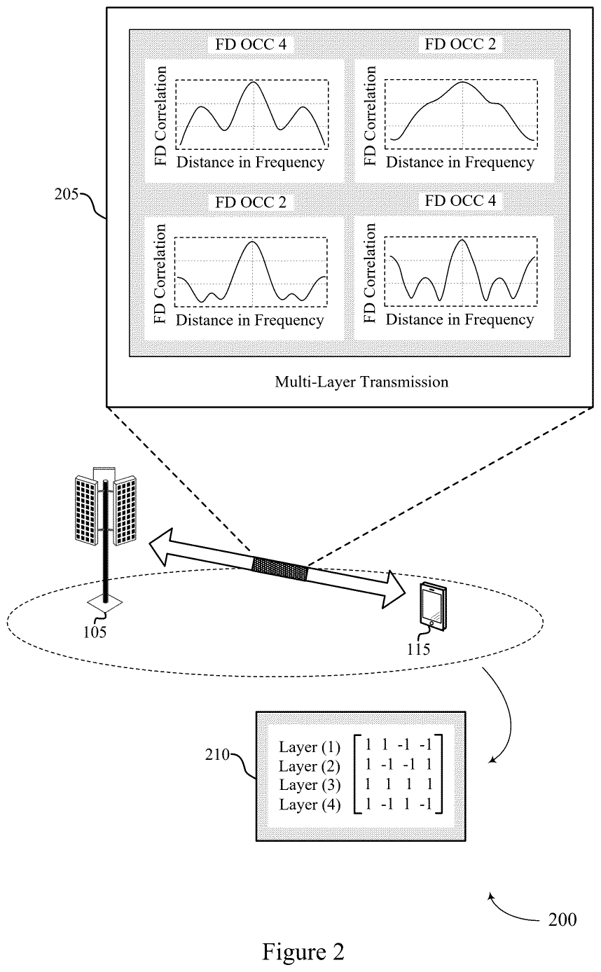

FIG. 2 shows an example of a signaling configuration 200 that supports channel estimation techniques for mixed length OCCs. For example, the signaling configuration 200 illustrates communications between a UE 115 and a network entity 105, each of which may be examples of UEs 115 and network entities 105 described with reference to FIG. 1. Both the UE 115 and the network entity 105 may each be examples of both transmitting devices and receiving devices described herein.

A receiving device (e.g., a UE 115 or a network entity 105) may use DMRS to estimate a radio channel for demodulation of a corresponding physical channel. For example, the UE 115 may use the DMRS to perform channel estimation for PDSCH data demodulation and PUSCH data demodulation. In some aspects, a front-loaded DMRS structure may be used to achieve low-latency decoding. In a time-frequency resource grid, the front-loaded DMRS can be located after the control region, followed by a data region. The UE 115 may estimate the channel using the front-loaded DMRS, and may coherently demodulate the data in the data region. Additional DM-RS occasions/symbols may be present in (or configured for) a later part of the slot, which may be used to support high-speed (high mobility) scenarios, and may be used in addition to (or alternatively) with front loaded DMRS (e.g., the first occurrence of DMRS in a slot).

The signaling configuration 200 may support multiple stream transmissions such as the multi-layer transmission 205, which allows a UE 115, a network entity 105, or both, to transmit multiple streams (or multiple layers) of data. In order to support multi-stream (multi-layer) MIMO transmission, multiple orthogonal DMRS sequences are used, one DMRS sequence may be used for each stream or layer. In some examples, a single antenna port may be assigned to the demodulation of each stream or layer. Because the DMRS of a stream may be independently decoded from other DMRS of other streams for channel estimation of that stream, the DMRS sequences may be orthogonally separated to avoid interference. In some examples, orthogonality may be achieved by Frequency Division Multiplexing (FDM) (e.g., using a comb structure), Time Division Multiplexing (TDM), and/or Code Division Multiplexing (CDM) (e.g., with cyclic shift of the base sequence or OCCs).

In some examples, an OCC scheme may be implemented across OFDM symbols or slots. For example, the UEs 115 (e.g., a transmitting device) may receive data symbols from the output of a modulator, select the OCC codeword from an OCC matrix 210 (e.g., a row of a Hadamard matrix), which may be indicated in control signaling received from a network entity 105, or autonomously selected, perform an M factor cover coding of symbols using OCC, and transmit the OCC-configured data. The network entity 105 may receive the OCC-configured data symbols, decode the OCC for the corresponding UE 115 (e.g., using the corresponding Hadamard matrix), and send the decoded sequence to a demodulator for calculations (e.g., log-likelihood ratio (LLR) calculations). The OCC may be performed on a symbol-wise or slot-wise basis (e.g., symbol-by-symbol or slot-by-slot).

The UE 115 may apply an OCC in order to spread one slot into M slots, where OCC may be applied to generate orthogonal transmissions for two or more UEs, or two or more layers. For example, for a first layer, a first encoded slot

$${S}_{1}^{0}$$

(where

$${S}_{i}^{j}$$

corresponds to a slot j at UE i) may be input to an OCC matrix and for a second layer, a second encoded slot

$${S}_{2}^{0}$$

may be input into the C matrix 210. In some examples, the OCC matrix 210 may be a 2×2 matrix (e.g., two rows and two columns). For example, the OCC matrix 210 may be a Hadamard matrix, an identity matrix, a DFT matrix or any other orthogonal matrix. In OCC, each row or column of the OCC matrix 210 may be used as a codeword. To be compatible with OCC, each row or column of a matrix may be orthogonal. For example, for a 2×2 OCC matrix, the first row may correspond to a vector [1,1] that, when given as an input the first slot, outputs a product including two spread slots

$$( e . g . , {S}_{1}^{0} , and {S}_{1}^{0} )$$

that have the same values as the input of the first encoded slot. The second row of the OCC matrix may correspond to a vector of [1, −1]. The second row, when given the second encoded slot

$${S}_{2}^{0}$$

as an input, outputs a product including two respective spread slots

$$( e . g . , {S}_{2}^{0} , - {S}_{2}^{0} )$$

including a slot with a same value as the input slot, and a negative output of the input slot. Applying the matrix in this manner to the input slots produces orthogonal outputs, and accordingly, transmissions from two layers are orthogonal and therefore do not interfere with one another.

In some examples, the OCC matrix 210 may be a 4×4 Hadamard matrix having four rows and four columns. In such examples, the matrix may include a first row vector of [1, 1, 1, 1], a second row vector of [1, −1, −1, 1], a third row vector [1, 1, 1, 1], and a fourth row vector [1, −1, 1, −1] (although other combinations of mutually orthogonal row vectors different from those illustrated and described herein are possible). As described herein, the OCC matrix 210 with mutually orthogonal row vectors of may be used for multiplexing four layers, and any orthogonal matrix may be used as an OCC matrix 210 for multiplexing any quantity of layers. For example, any orthogonal 2×2 matrix may be used for two layers (e.g., two layers per DMRS symbol), an orthogonal 4×4 matrix may be used for four layers (e.g., four layers per DMRS symbol), and additional orthogonal matrices may be used for different quantities of layers.

Each CDM group (e.g., multiplexing group) may include DM-RS ports that are mapped to REs as a group. DMRS ports in the same CDM group may be multiplexed using the same resources and using an OCC. For example, an FD-OCC may be used to multiplex two DMRS ports together into a pair of symbols, so each pair of REs in the two symbol DM-RS configurations use a length-2 OCC (e.g., FD-OCC 2). Additionally, an FD-OCC may additionally, or alternatively, be used to multiplex four DMRS ports together (e.g., FD-OCC 4) to reduce DMRS overhead and to support an increased quantity of layers per DMRS symbol (e.g., up to 8 layers per DMRS symbol). In some cases, however, when applied to a frequency-selective channel (e.g., a channel that is not flat or relatively flat across eight tones), channel estimation is less accurate for FD-OCC 4, since the channel estimation of a given layer may suffer from interference from other multiplexed layers. Such inaccuracies in channel estimation may reduce throughput performance and channel estimation accuracy. For example, throughout degradation may occur for frequency selective channels (e.g., a tapped delay line (TDL)-C 300 ns frequency selective channel) using FD-OCC 4. In some implementations, channel precoding may be applied in order to improve throughput performance. For example, singular value decomposition (SVD) precoding may be applied for transmissions, and the frequency domain correlation of the frequency response of the first layer (corresponding to the largest singular value) may be much flatter in frequency than unprecoded channels. Frequency domain correlations may also decrease gradually for the second layer (or higher layers) corresponding to decreasing singular values.

In some aspects, the receiving device (e.g., the UE 115) may perform channel estimation using FD-OCC 4 for the first or second layers, or otherwise the layers with the highest frequency domain correlation in the multi-layer transmission 205, while using FD-OCC 2 for higher layers (e.g., weaker layers with lower frequency domain correlation in the multi-layer transmission 205). That is, the receiving device (such as the UE 115) may use one length of OCC (e.g., FD-OCC 4) for one type of channel that has a flatter frequency profile, and may use another length of OCC (e.g., FD-OCC 2) for another type of channel that has a less flat frequency profile (e.g., a frequency selective channel where different frequency components experience varying degrees of attenuation, leading to moderate signal distortion). For example, shorter length OCC codes may be better equipped to handle frequency selective channels because shorter length OCC codes may require fewer consecutive flat tones (e.g., M consecutive tones) to maintain accurate encoding and decoding.

In some implementations, a receiving device (such as the UE 115 or the network entity 105) may use channel estimation techniques with mixed OCC for different quantities of layers (e.g., eigen layers, MIMO layers, transmission layers). For example, for a three layer channel estimation (although other quantities of layers are possible), a UE 115 may use mixed OCC decoding using de-OCC 2 and de-OCC 4 in order to decode the three layers. The UE 115 may use a 4×4 orthogonal matrix (such as a Hadamard matrix) as an OCC matrix 210, and may assign 3 of 4 OCCs present in the OCC matrix for de-OCC 2 and de-OCC 4. For example, the OCC matrix 210 may be given as:

$$\begin{matrix}( 1 ) \\ ( 2 ) \\ ( 3 ) \\ ( 4 )\end{matrix} [ \begin{matrix}1 & 1 & - 1 & - 1 \\ 1 & - 1 & - 1 & 1 \\ 1 & 1 & 1 & 1 \\ 1 & - 1 & 1 & - 1\end{matrix} ] = [ \begin{matrix}{x}_{1}^{T} \\ {x}_{2}^{T} \\ {x}_{3}^{T} \\ {x}_{4}^{T}\end{matrix} ]$$

where [1 1 −1 −1] is the OCC corresponding to the first layer

$$( {x}_{1}^{T} ) ,$$

[1 −1 −1 1] is the OCC corresponding to the second layer

$$( {x}_{2}^{T} ) ,$$

[1 1 1 1] is the Que corresponding to the third layer

$$( {x}_{3}^{T} ) ,$$

and [1 −1 1 −] is the OCC corresponding to the fourth layer

$$( {x}_{4}^{T} ) .$$

In some examples, the transmitter (e.g., the UE 115, the network entity 105), may assign the first and second (relatively) strongest layers (e.g., eigen layers, transmission layers) that correspond with a relatively flatter frequency correlation (e.g., frequency response) with OCC rows (1) and (3), and may assign the weakest layer (of the three layers) that corresponds to more frequency selective channel to the OCC row (4). In such cases, the received signal at the i^{th} receiver antennas and four corresponding DMRS tones may be:

yᵢ=h_{1,i}·x₁+h_{3,i}·x₃+h_{4,i}·x₄,

where h_{l,i} is the signal component for the l-th layer where h_{l,i}∈4×1 is the channel for the l-th layer and yᵢ∈C^{4×1}, and xᵢ is the associated signal contribution for the l-th layer.

In some such examples, to perform channel estimation, the receiving device may use de-OCC 4 on the first and third layers (e.g., layers (1) and (3)), and may use de-OCC 2 on the fourth layer (e.g., layer (4)). For example, the interference from layers (1) and (3) may be orthogonal to layer (4), and may be canceled from the signal of layer (4) during channel estimation, for example, using successive interference cancellation. That is, the first two values of the OCC sequence for layers (1) and (3) are [1 1], and the first two values of the OCC sequence for layer (4) is [1 −1], thus being orthogonal to the layers (1) and (3) when OCC 2 is used (e.g., the first two values of the OCC sequence are compared because of the de-OCC 2 using a 2×2 matrix for decoding, rather than the full 4×4 OCC matrix). Additionally, or alternatively, the receiver may use de-OCC 4 on the second and fourth layers (e.g., layers (2) and (4)), and may use de OCC 2 on the third layer (e.g., layer (3)). For example, the interference from layers (2) and (4) may be orthogonal to layer (3), and may be canceled from the signal of layer (3) during channel estimation. That is, the first two values of the OCC sequence for layers (3) and (4) are [1 −1], and the first two values of the OCC sequence for layer (3) is [1 1], thus being orthogonal to the layers (2) and (4) when OCC-2 is used.

In some other examples, the receiving device may perform de-OCC 4 on the first or second layer (e.g., layers (1) or (2)), but may be unable to null the interference from the de-OCC 2 layer. In such cases, the receiver may perform successive cancellation from the de-OCC 2 layer, where the receiving device performs channel estimation on the de-OCC 2 layer (e.g., layer (3) or layer (4)), and may cancel out the interference from the de-OCC 2 layer from the received signal prior to performing de-OCC 4 (e.g., \tilde{y}=y−ĥ₄·x₄≈h₁·x₁+h₂·x₂, where the reconstructed channel y is equal to the interference from the de-OCC 2 layer \tilde{h}₄·x₄ subtracted from the received signal y).

In some implementations, a receiving device may use channel estimation techniques with mixed OCC for a four layer channel estimation (although other quantities of layers are possible), for example, the UE 115 may use mixed OCC decoding using de-OCC 2 and de-OCC 4 to decode the four layers. The UE 115 may use a 4×4 orthogonal matrix (such as a Hadamard matrix, described herein) as an OCC matrix 210 where [1 1 −1 −1] is the OCC corresponding to the first layer

$$( {x}_{1}^{T} ) ,$$

[1 −1 −1 1] is the OCC corresponding to the second layer

$$( {x}_{2}^{T} ) ,$$

[1 1 1 1] is the OCC corresponding to the third layer

$$( {x}_{3}^{T} ) ,$$

and [1 −1 1 −1] is the OCC corresponding to the fourth layer

$$( {x}_{4}^{T} ) .$$

For such four CDM examples, the UE 115 may apply a de-OCC association for decoding the four layers by using de-OCC 4 for layers (1) and (2), and using de-OCC 2 for layers (3) and (4). In some examples, the last two rows (e.g., layers (3) and (4)) are equivalent to FD-OCC 2, so if (only) the last two rows are transmitted, the receiving device may perform de-OCC2 for channel estimation.

In some cases, if the transmitting device (such as a network entity) transmits four layers of DMRS, the transmitting device may assign the first and second strongest eigen layers (which correspond to the relatively flattest frequency domain correlations) with rows 1 and 2 (e.g., layers (1) and (2)) and may assign the relatively weakest two layers (of the four layers) that correspond to more frequency selective channel to rows 3 and 4 (e.g., layers (3) and (4)). In such cases, the received signal at a receiver antenna i and four DMRS tones may be expressed as:

yᵢ=h_{1,i}·x₁+h_{2,i}·x₂+h_{3,i}·x₃+h_{4,i}·x₄,

where h_{l,i} is the signal component for the l-th layer where h_{l,i}∈N_{RX}×1 is the channel for the l-th layer and yᵢ∈C^{4×1}, and xᵢ is the associated signal contribution for the l-th layer.

In some examples of channel estimation with mixed OCC for three and four layers, where de-OCC 4 is performed first, with successive interference cancellation prior to channel estimation for de-OCC 2, xᵢ may be orthogonal if the receiver perform de-OCC4. For example, x₁ and x₂ may be orthogonal for all xᵢ for de-OCC 4, where x₃ and x₄, x₂ and x₃, x₁ and x₄ are orthogonal for de-OCC 2. To estimate the channel for the first and second layer, the receiving device may perform de-OCC 4, because the interference from the channel corresponding to layers (3) and (4) may be orthogonal or almost (e.g., substantially) orthogonal (the first and the second layer may be stronger with singular value decomposition precoding). To estimate the channel for the third and fourth layer, due to the relatively low frequency domain correlations, the receiver may perform de-OCC2, and may null (e.g., cancel) the interference from the fourth and third layer. In such cases, the de-OCC2 may be unable to null the interference from the first and second layer. Alternatively, in some examples, the receiver may estimate the first and second layer channel, and cancel the associated signal components out from the received signal before performing de-OCC2, such that \tilde{y}=y−ĥ₁·x₁−ĥ₂·x₂≈h₃·x₃+h₄·x₄.

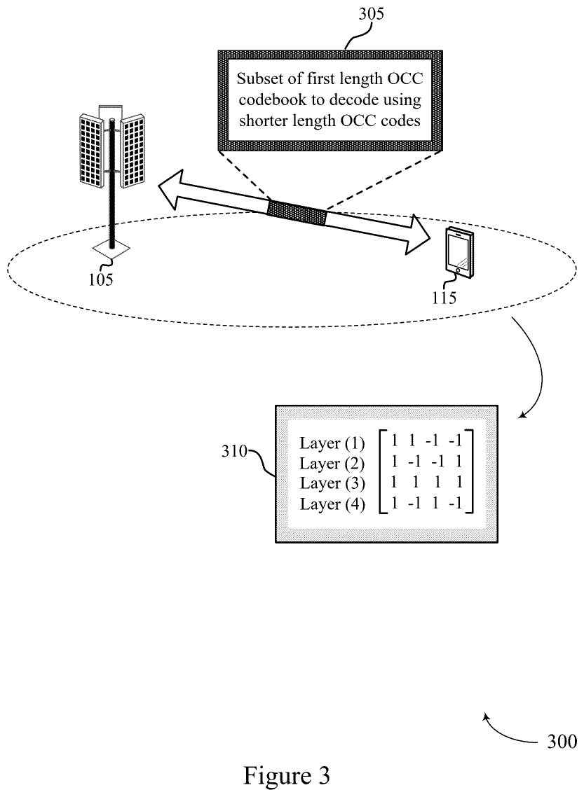

FIG. 3 shows an example of a signaling configuration 300 that supports channel estimation techniques for mixed-length OCCs. For example, the signaling configuration 300 illustrates communications between a UE 115 and a network entity 105, each of which may be examples of UEs 115 and network entities 105 described with reference to FIGS. 1 and 2. Both the UE 115 and the network entity 105 may each be examples of both transmitting devices and receiving devices described herein.

In some implementations, the network entity 105 may configure (e.g., via RRC signaling) and/or indicate (e.g., via DCI) a subset of an OCC codebook that may be decoded using OCCs of a shorter length. For example, the network entity 105 may transmit one or more messages 305 to indicate or configure a subset of an OCC 4 codebook that may be decoded by the UE 115 using OCC 2 codes. In some examples, the subset of the OCC codebook (including a subset of the longer length OCC codes that can be decoded using the shorter length OCC codes) may correspond to layers that have a frequency domain correlation that is less than a threshold frequency domain correlation. In some examples, the longer length OCCs that are included in the subset of the OCC codebook may be orthogonal to shorter length OCCs.

In a four layer example, various different subsets of the length-4 OCCs (included in the OCC matrix 310) may be decoded using a length-2 OCC (e.g., de-OCC 2). For example, the layers x₃ and x₄ may be a subset of layers that are orthogonal under de-OCC 2 with [1 1], [1 −1] in every two DMRS tones (e.g., the first two values of the OCC for layer x₃ in the OCC matrix 310 is [1 1] and the first two values of the OCC for layer x₄ in the OCC matrix 310 is [1 −1], which is orthogonal to [1 1]). Additionally, or alternatively, x₂ and x₃ may be a subset of layers that are orthogonal under de-OCC 2 with [1,1], [1 −1] in the first two DMRS tones every four DMRS tones (corresponding to the first two values of the OCC code sequence in the OCC matrix 310 for layers x₂ and x₃). Additionally, or alternatively, x₂ and x₃ may be orthogonal with [1 1], [−1 1] in the last 2 tones every four DMRS tones (corresponding to the last two values of the OCC code sequence in the OCC matrix 310 for layers x₂ and x₃).

Additionally, or alternatively, x₁ and x₄ may be a subset that are orthogonal under de-OCC 2 with [1,1], [−1 −1] in first two DMRS tones every 4 DMRS tones (corresponding to the first two values of the OCC code sequence in the OCC matrix 310 for layers x₁ and x₄), or [−1 −1], [1 −1] in the last two tones every four DMRS tones (corresponding to the last two values of the OCC code sequence in the original 4×4 matrix for layers x₁ and x₄). In a three layer example, one layer may be decoded using a length 2 OCC. For example, a single code may be present in the subset of the de-OCC 4 group that may be decoded using the de-OCC 2. In such examples, the de-OCC 2 group may include layers x₃ or x₄.

The network entity 105 may assign the subset of the length-4 OCC codebook that can be decoded using OCC-2 codes iteratively based on an evaluation of the frequency domain correlations per layer. For example, the network entity 105 may identify a first layer that has a relatively weakest frequency domain correlation of all layers (e.g., a frequency domain correlation that is farthest below the frequency domain correlation threshold), and may assign the first layer to the short de-OCC group (e.g., the subset of the length-4 OCC codebook that can be decoded using an OCC-2 code). The network entity 105 may identify a second layer that has a second-weakest frequency domain correlation (a frequency domain correlation that is less than the frequency domain correlation threshold), and may assign the second layer to the short de-OCC group. The network entity may identify a third layer, a fourth layer, or both, with relatively stronger frequency domain correlations (e.g., frequency domain correlations that exceed the frequency domain correlation threshold) and may assign the third layer, the fourth layer, or both, to the long de-OCC group (e.g., the layers being decoded using the length-4 OCCs). While the assignment of layers to different OCC groups is provided as two layers per OCC group, any different combination of layers may be assigned to the short and long OCC groups based on the comparison of the respective per-layer frequency domain correlation to the frequency domain correlation threshold.

In some examples, the subset of the length-4 OCC codebook that can be decoded using OCC-2 codes may be configured for the UE 115 using the one or more messages 305, which may be an example of semi-static or static RRC signaling, or may be an example of dynamic layer 1 and/or layer 2 signaling. For example, in a single user MIMO setting, scheduling decisions made by the network entity 105 may be relatively more static (e.g., depending on factors such as rank and precoding), the network entity 105 may statically or semi-statically configured the subset of the length-4 OCC codebook that can be decoded using OCC-2 codes using RRC signaling (e.g., via an RRC configuration). In a multi-used MIMO setting, the choice of different OCCs may be coordinated across links (e.g., dynamically) by the network entity 105, and the network entity 105 may use dynamic configuration such as DCI or MAC-CE signaling to indicate the subset of the length-4 OCC codebook that can be decoded using OCC-2 codes.

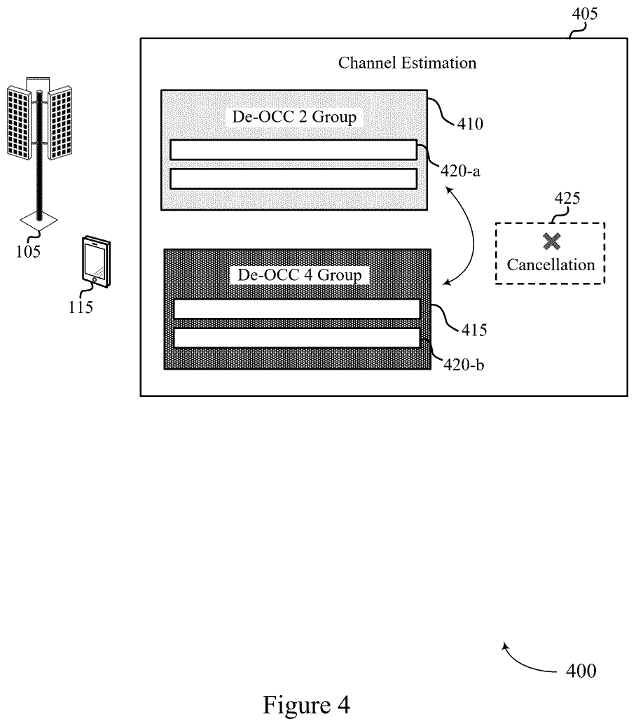

FIG. 4 shows an example of a channel estimation scheme 400 that supports channel estimation techniques for mixed length OCCs. For example, the channel estimation scheme 400 may support channel estimation techniques performed by a UE 115, a network entity 105, or both, each of which may be examples of UEs 115 and network entities 105 described with reference to FIGS. 1 through 3. Both the UE 115 and the network entity 105 may each be examples of both transmitting devices and receiving devices described herein.

The receiving device (e.g., the UE 115, the network entity 105) may perform channel estimation 405 on different layers based on a layer ordering, which may be based on a de-OCC grouping (e.g., a grouping of OCC codes that include layers that are decoded using length-4 OCC codes, such as de-OCC group 415 and layers that are decoded using length-2 OCC codes, such as de-OCC group 410). In some examples, the receiving device may perform channel estimations for the layers in a first de-OCC group simultaneously (e.g., all at once for all of the layers 420-a or layers 420-b in the de-OCC group), or layer-by-layer (e.g., one layer at a time, sequentially). After the receiving device performs the channel estimation 405 for the layers in the first de-OCC group (either simultaneously or sequentially), the receiving device may then perform channel estimation 405 for the layers in a second de-OCC group. In some examples, the receiving device may decode the shorter de-OCC group first (e.g., de-OCC group 410, the de-OCC group that includes layers that are to be decoded using length-2 OCC codes) followed by the longer de-OCC group (e.g., de-OCC group 415, the de-OCC group that includes layers that are to be decoded using the length-4 OCC codes). In some examples, the receiving device may decode the longer de-OCC group first (e.g., e.g., de-OCC group 415, the de-OCC group that includes layers that are to be decoded using length-4 OCC codes) followed by the shorter de-OCC group (e.g., de-OCC group 410, the de-OCC group that includes layers that are to be decoded using the length-2 OCC codes). In some such examples, for an OCC 4 codebook, the de-OCC group channel estimation ordering may be based on the total quantity of layers that are to be decoded. For example, for three total layers, the receiving device may decode the shorter de-OCC group first (e.g., de-OCC group 410), followed by the longer de-OCC group (e.g., de-OCC group 415), and for four total layers, the receiving device may decode the longer de-OCC group first, followed by the shorter de-OCC group.

In some implementations, the receiving device may cancel the estimated channel in the prior de-OCC group from the received signal using successive cancellation 425 prior to performing channel estimation (or de-OCC) for the layers in the later de-OCC group. For cases in which the receiving device performs channel estimation for three layers (e.g., rank 3), the receiving device may perform channel estimation for all of the layers in the de-OCC 2 group (e.g., [symbol] ). The receiving device may multiply the corresponding OCC on the estimated channel to cancel out interference from the de-OCC 2 group, and may perform channel estimation for the de-OCC 4 group after the interference is canceled from the received signal (e.g., \tilde{y}=y−ĥ₄·x₄≈h₁·x₁+h₂·x₂, where the reconstructed channel y is equal to the interference from the de-OCC 2 layer ĥ₄·x₄ subtracted from the received signal y). For cases in which the receiving device performs channel estimation for four layers (e.g., rank 4), the receiving device may perform channel estimation for all of the layers in the de-OCC 4 group (e.g., ĥ₁, ĥ₂), which correspond to the strongest layers, or the layers having the highest frequency domain correlation. The receiving device may then cancel the signal components from all layers in the de-OCC 4 group from the received signal prior to performing channel estimation for the de-OCC 2 group (e.g., \tilde{y}=y−ĥ₁·x₁−h₂·x₂≈h₃·x₃+h₄·x₄, where the reconstructed channel \tilde{y} is equal to the interference from the de-OCC 4 layers \tilde{h}₁·x₁ and ĥ₂·x₂ subtracted from the received signal y).

In some examples, the transmitting device may perform power boosting (e.g., DMRS power boosting) for transmission layers in the earlier de-OCC group in order to reduce the effects of potential signal distortion. For example, in a four-layer (e.g., rank 4) case, a receiving device may perform channel estimation on each layer in the de-OCC 4 group prior to performing channel estimation on the de-OCC 2 group so that the signal components of the de-OCC 4 group may be canceled from the received signal prior to performing channel estimation for the de-OCC 2 group. Even if the layers in the de-OCC 4 group have relatively higher frequency domain correlation, power boosting the signal may further reduce channel estimation error since the receiving device may successively cancel out the estimated channels from the earlier de-OCC group from the received signal.

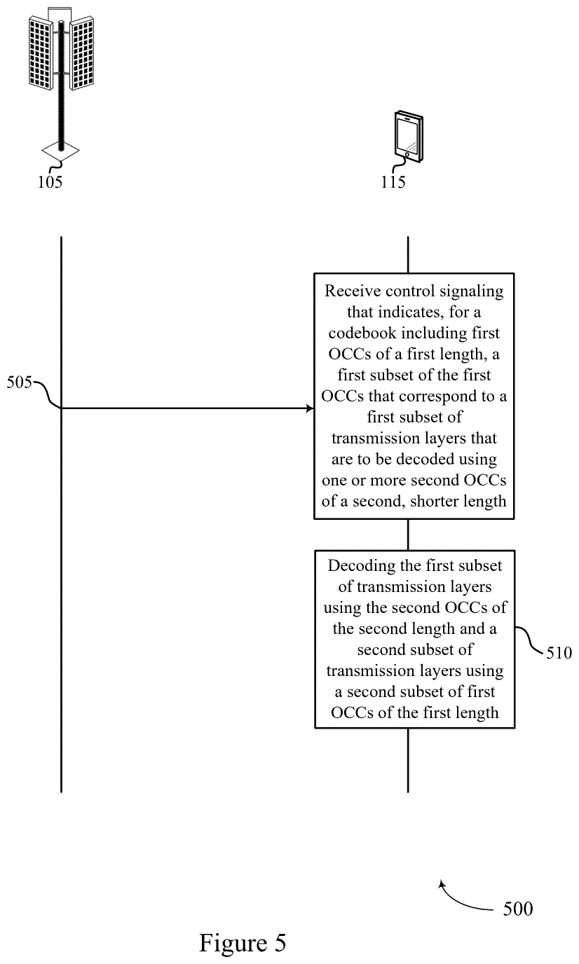

FIG. 5 shows an example of a process flow 500 that supports channel estimation techniques for mixed length OCCs. For example, the process flow 500 may support communications between a UE 115 and a network entity 105, each of which may be examples of corresponding devices described herein. In some aspects, the UE 115 may support OCC techniques described herein.

Alternative examples of the following may be implemented. Some steps are performed in a different order than described or are not performed at all. In some implementations, steps may include additional features not mentioned below, or additional steps may be added. Further, although the UE 115 and the network entity 105 are shown performing the operations of the process flow 500, some aspects of some operations may also be performed by one or more other wireless communication devices (such as by multiple network entities, multiple UEs).

At 505, the UE 115 may receive from the network entity 105, control signaling (e.g., one or more messages 305) that indicates, for a codebook associated with a set of transmission layers (e.g., eigen layers, MIMO layers, included in the multi-layer transmission 205) and including a set of first OCCs of a first length (e.g., OCC-4). In some examples, the control signaling may also indicate a first subset of one or more first OCCs (from the set of first OCCs) that correspond to a first subset of one or more transmission layers from the set transmission layers that are to be decoded by the UE 115 using one or more second OCCs of a second length (e.g., OCC-2). In some such examples, the second length (of the one or more second OCCs) may be shorter than the first length (of the set of first OCCs).

At 510, the UE 115 may decode (e.g., de-OCC), in accordance with the information received in the control signaling, the first subset of one or more transmission layers using the one or more second OOCs of the second length (e.g., de-OCC 2), and a second subset of one or more transmission layers from the set of transmission layers using a second subset of one or more first OCCs from the first set of OCCs of the first length (e.g., de-OCC 4, such as the OCCs included in the OCC matrix 210 or the OCC matrix 310).

In some examples, each of the one or more second OCCs of the second length is orthogonal to each other of the one or more second OCCs of the second length. In some examples, each of the one or more second OCCs of the second length includes a portion of a respective first OCC from the set of first OCCs of the first length (e.g., each of the one or more second OCCs include a set of two values from a length-4 OCC sequence).

In some examples, each OCC of the first subset of one or more OCCs corresponds to a respective transmission layer in the first subset of one or more transmission layers, and each transmission layer in the first subset of one or more transmission layers has a frequency domain correlation that is less than a frequency domain correlation threshold. For example, the UE 115 and/or the network entity 105 may identify which OCCs to assign to the subset of OCCs having the shorter OCC length based on whether a layer associated with an OCC has a frequency domain correlation that is less than the frequency domain correlation threshold. In some cases, to assign the transmission layers to different OCC lengths, a first transmission layer having a lowest frequency domain correlation from among the set of transmission layers is assigned to a first OCC that is to be decoded using a second OCC of the second length, and a second transmission layer having a highest frequency domain correlation from among the set of transmission layers is assigned to a different first OCC that is to be decoded using a first OCC of the first length. In some examples, the UE 115 and/or the network entity 105 may iteratively assign the different transmission layers to different OCC lengths based on the frequency domain correlation of a given layer relative to the frequency domain correlation threshold.

In some implementations, the set of transmission layers is four transmission layers, and the first subset of one or more transmission layers is two transmission layers. In such implementations, the UE 115 may decode each of the two transmission layers using respective second OCCs from among the one or more second OCCs. In some examples, a respective second OCC for a first one of the two transmission layers is orthogonal to a respective second OCC for a second one of the two transmission layers. In some implementations, the set of transmission layers is three transmission layers, and the first subset of one or more transmission layers is one transmission layer. In such implementations, the UE 115 may decode the single transmission layer using a second OCC from among the one or more second OCCs.

In some examples, the set of transmission layers are configured in accordance with SU-MIMO communications, and the UE 115 may receive one or more RRC messages (e.g., semi-static and/or static signaling) that configure the first subset of one or more first OCCs that correspond to the first subset of one or more transmission layers that are to be decoded by the UE 115 using the one or more second OCCs of the second length. Additionally, or alternatively, if the set of transmission layers are configured in accordance with MU-MIMO communications, the UE 115 may receive one or more DCI messages, MAC-CEs, or both, (e.g., dynamic signaling) which indicate the first subset of one or more first OCCs that correspond to the first subset of one or more transmission layers that are to be decoded by the UE using the one or more second OCCs of the second length.

In some examples, the UE 115 may perform one or more first channel estimations for the first subset of one or more transmission layers that correspond to the one or more second OCCs of the second length, and may perform one or more second channel estimations for the second subset of one or more transmission layers that correspond to the one or more first OCCs of the first length. In some cases, the one or more first channel estimations are performed prior to the one or more second channel estimations, or the one or more first channel estimations are performed subsequent to the one or more second channel estimations (e.g., the UE 115 may first decode transmission layers using de-OCC 2 and then using de-OCC 4, or the UE 115 may first decode transmission layers using de-OCC 4 and then using de-OCC 2). In some such cases, the one or more first channel estimations are performed simultaneously for all transmission layers in the first subset of one or more transmission layers or are performed sequentially layer-by-layer for the transmission layers in the first subset of one or more transmission layers, and the one or more second channel estimations are performed simultaneously on all transmission layers in the second subset of one or more transmission layers or are performed sequentially layer-by-layer for the transmission layers in the second subset of one or more transmission layers.

In some decoding examples, the UE 115 may perform successive interference cancellation of one or more transmission layers from the received signal prior to decoding the rest of the received signal. For example, the UE 115 may cancel, prior to performing the one or more second channel estimations, one or more signal components associated with the first subset of one or more transmission layers from a received signal that corresponds to the second subset of one or more transmission layers. Additionally, or alternatively, the UE 115 may cancel, prior to performing the one or more first channel estimations, one or more signal components associated with the second subset of one or more transmission layers from a received signal that corresponds the first subset of one or more transmission layers. In some such examples, the DMRS transmit power associated with the first subset of one or more transmission layers may be higher than a DMRS power associated with the second subset of one or more transmission layers, or a DMRS power of the second subset of one or more transmission layers may be higher than a DMRS power of the first subset of one or more transmission layers.

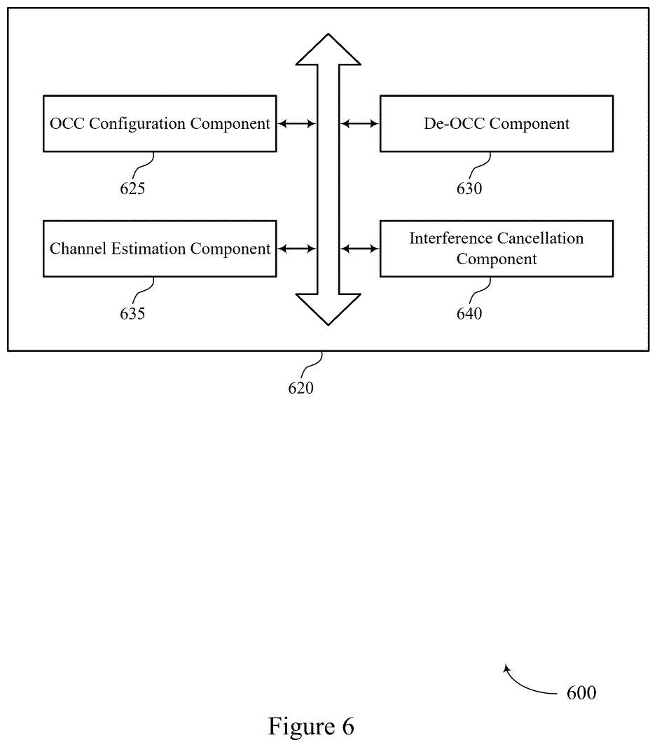

FIG. 6 shows an example 600 of a processing system 620 that supports channel estimation techniques for mixed length OCCs. A processing system 620 may be an example of a processing system 140 (such as of a UE 115) and may include a OCC configuration component 625, a de-OCC component 630, a channel estimation component 635, an interference cancellation component 640, or any combination thereof. A processing system 620, or various component thereof, may be an example of means for performing (such as a means for causing a UE 115 to perform) various techniques described herein.

The OCC configuration component 625 may be configured to cause the UE 115 to receive control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded by the UE using one or more second OCCs of a second length, the second length shorter than the first length. The de-OCC component 630 may be configured to cause the UE 115 to decode, in accordance with the control signaling, the first subset of one or more transmission layers using the one or more second OCCs of the second length and a second subset of one or more transmission layers from the set of multiple transmission layers using a second subset of one or more first OCCs from the set of first OCCs of the first length.

In some examples, each of the one or more second OCCs of the second length is orthogonal to each other of the one or more second OCCs of the second length. In some examples, each of the one or more second OCCs of the second length includes a portion of a respective first OCC from the set of first OCCs of the first length.

In some examples, each OCC of the first subset of one or more first OCCs corresponds to a respective transmission layer in the first subset of one or more transmission layers, and each transmission layer in the first subset of one or more transmission layers has a frequency domain correlation that is less than a frequency domain correlation threshold.

In some examples, in accordance with the set of multiple transmission layers being assigned to respective OCCs from the set of first OCCs in accordance with respective frequency domain correlations: a first transmission layer having a lowest frequency domain correlation from among the set of multiple transmission layers is assigned to a first OCC that is to be decoded using a second OCC of the second length, and a second transmission layer having a highest frequency domain correlation from among the set of multiple transmission layers is assigned to a different first OCC that is to be decoded using a first OCC of the first length.

In some examples, to support decoding the first subset of one or more transmission layers using the one or more second OCCs, the de-OCC component 630 may be configured to cause the UE 115 to decode each of the two transmission layers using respective second OCCs from among the one or more second OCCs, where a respective second OCC for a first one of the two transmission layers is orthogonal to a respective second OCC for a second one of the two transmission layers. In some examples, to support decoding the first subset of one or more transmission layers using the one or more second OCCs, the de-OCC component 630 may be configured to cause the UE 115 to decode the single transmission layer using a second OCC from among the one or more second OCCs.

In some examples, the multiple transmission layers may be in accordance with SU-MIMO communications. In some examples, to support receiving the control signaling, the OCC configuration component 625 may be configured to cause the UE 115 to receive one or more RRC messages that configure the first subset of one or more first OCCs that correspond to the first subset of one or more transmission layers that are to be decoded by the UE using the one or more second OCCs of the second length.

In some examples, the multiple transmission layers may be in accordance with MU-MIMO communications. In some examples, to support receiving the control signaling, the OCC configuration component 625 may be configured to cause the UE 115 to receive a MAC-CE, DCI, or both, that indicates the first subset of one or more first OCCs that correspond to the first subset of one or more transmission layers that are to be decoded by the UE using the one or more second OCCs of the second length.

In some examples, the channel estimation component 635 may be configured to cause the UE 115 to perform one or more first channel estimations for the first subset of one or more transmission layers that correspond to the one or more second OCCs of the second length. In some examples, the channel estimation component 635 may be configured to cause the UE 115 to perform one or more second channel estimations for the second subset of one or more transmission layers that correspond to the one or more first OCCs of the first length.

In some examples, the one or more first channel estimations are performed prior to the one or more second channel estimations, or the one or more first channel estimations are performed subsequent to the one or more second channel estimations.

In some examples, the one or more first channel estimations are performed simultaneously for all transmission layers in the first subset of one or more transmission layers or are performed sequentially layer-by-layer for the transmission layers in the first subset of one or more transmission layers, and the one or more second channel estimations are performed simultaneously on all transmission layers in the second subset of one or more transmission layers or are performed sequentially layer-by-layer for the transmission layers in the second subset of one or more transmission layers.

In some examples, the interference cancellation component 640 may be configured to cause the UE 115 to cancel, prior to performing the one or more second channel estimations, one or more signal components associated with the first subset of one or more transmission layers from a received signal that corresponds to the second subset of one or more transmission layers. In some examples, a DMRS transmit power associated with the first subset of one or more transmission layers is higher than a DMRS transmit power associated with the second subset of one or more transmission layers. In some examples, the interference cancellation component 640 may be configured to cause the UE 115 to cancel, prior to performing the one or more first channel estimations, one or more signal components associated with the second subset of one or more transmission layers from a received signal that corresponds the first subset of one or more transmission layers. In some examples, a DMRS transmit power associated with the second subset of one or more transmission layers is higher than to a DMRS transmit power associated with the first subset of one or more transmission layers. In some examples, the set of multiple transmission layers include a set of multiple MIMO communication layers.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for communication reliability, reduced latency, more efficient utilization of communication resources, improved coordination between devices, improved utilization of processing capability, reduced DMRS overhead, improved channel estimation accuracy, increased throughput performance, and improved OCC efficiency as applied to a frequency selective channels.

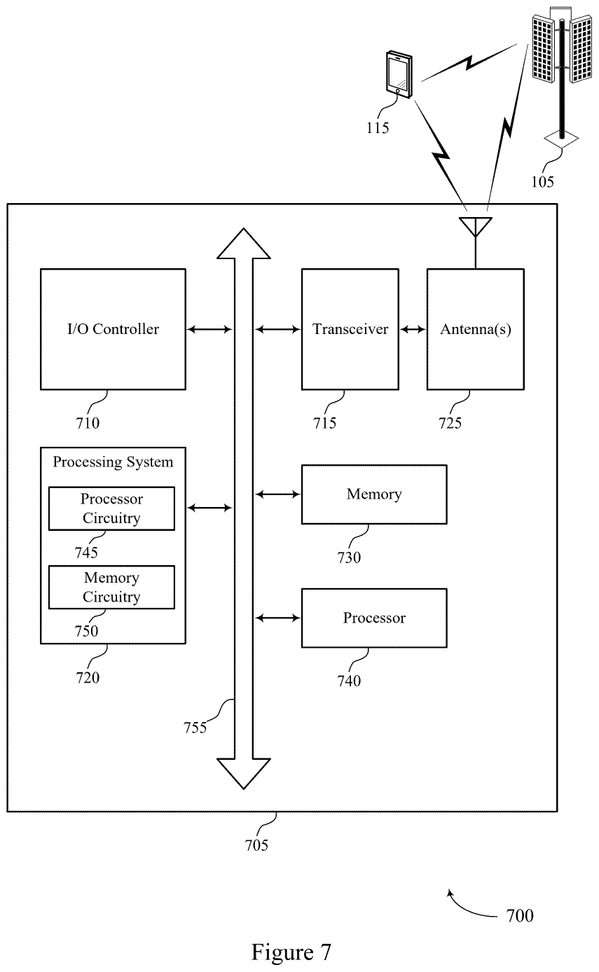

FIG. 7 shows an example of a system 700 including a device 705 that supports channel estimation techniques for mixed length OCCs. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support channel estimation techniques for mixed length OCCs. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, reduced latency, more efficient utilization of communication resources, improved coordination between devices, improved utilization of processing capability, reduced DMRS overhead, improved channel estimation accuracy, increased throughput performance, and improved OCC efficiency as applied to a frequency selective channels.

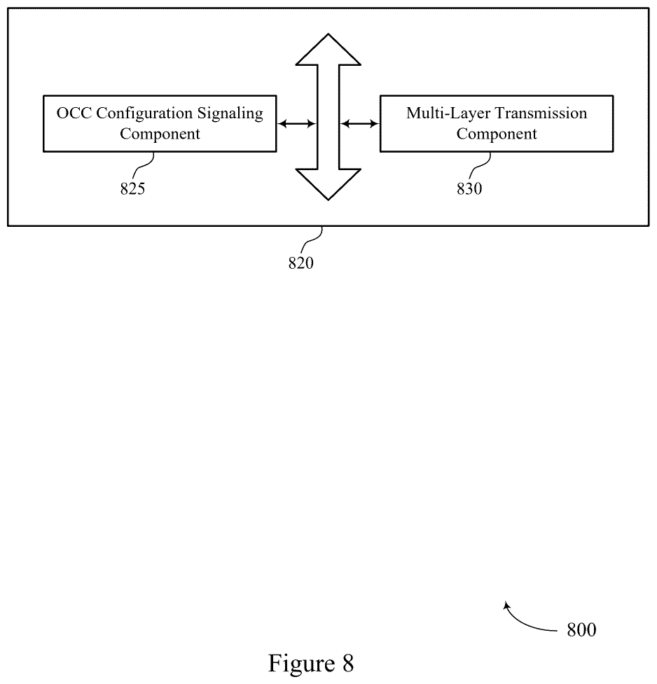

FIG. 8 shows an example 800 of a processing system 820 that supports channel estimation techniques for mixed length OCCs. A processing system 820 may be an example of a processing system 145 (such as network entity 105) and may include a OCC configuration signaling component 825 a multi-layer transmission component 830, or any combination thereof. A processing system 820, or various component thereof, may be an example of means for performing (such as a means for causing a network entity 105 to perform) various techniques described herein.

The OCC configuration signaling component 825 may be configured to cause the network entity 105 to output control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded using one or more second OCCs of a second length, the second length shorter than the first length. The multi-layer transmission component 830 may be configured to cause the network entity 105 to output, in accordance with the control signaling via a multi-layer transmission, the first subset of one or more transmission layers that are to be decoded using the one or more second OCCs of the second length and a second subset of one or more transmission layers from the set of multiple transmission layers that are to be decoded using a second subset of one or more first OCCs from the set of first OCCs of the first length.

In some examples, each of the one or more second OCCs of the second length is orthogonal to each other of the one or more second OCCs of the second length. In some examples, each of the one or more second OCCs of the second length includes a portion of a respective first OCC from the set of first OCCs of the first length.

In some examples, each OCC of the first subset of one or more first OCCs corresponds to a respective transmission layer in the first subset of one or more transmission layers, and each transmission layer in the first subset of one or more transmission layers has a frequency domain correlation that is less than a frequency domain correlation threshold.

In some examples, in accordance with the set of multiple transmission layers being assigned to respective OCCs from the set of first OCCs in accordance with respective frequency domain correlations: a first transmission layer having a lowest frequency domain correlation from among the set of multiple transmission layers is assigned to a first OCC that is to be decoded using a second OCC of the second length, and a second transmission layer having a highest frequency domain correlation from among the set of multiple transmission layers is assigned to a different first OCC that is to be decoded using a first OCC of the first length.

In some examples, the set of multiple transmission layers includes four transmission layers and the first subset of one or more transmission layers includes two transmission layers. In some examples, each of the two transmission layers are to be decoded using respective second OCCs from among the one or more second OCCs. In some examples, a respective second OCC for a first one of the two transmission layers is orthogonal to a respective second OCC for a second one of the two transmission layers.

In some examples, the set of multiple transmission layers includes three transmission layers and the first subset of one or more transmission layers includes a single transmission layer. In some examples, the single transmission layer is to be decoded using a second OCC from among the one or more second OCCs.

In some examples, the set of multiple transmission layers may be in accordance with SU-MIMO communications. In some examples, to support outputting the control signaling, the OCC configuration signaling component 825 may be configured to cause the network entity 105 to output one or more RRC messages that configure the first subset of one or more first OCCs that correspond to the first subset of one or more transmission layers that are to be decoded using the one or more second OCCs of the second length.

The set of multiple transmission layers may be in accordance with MU-MIMO communications. In some examples, to support outputting the control signaling, the OCC configuration signaling component 825 may be configured to cause the network entity 105 to output a MAC-CE, DCI, or both, that indicates the first subset of one or more first OCCs that correspond to the first subset of one or more transmission layers that are to be decoded using the one or more second OCCs of the second length. In some examples, the set of multiple transmission layers include a set of multiple MIMO communication layers.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for improved communication reliability, reduced latency, more efficient utilization of communication resources, improved coordination between devices, improved utilization of processing capability, reduced DMRS overhead, improved channel estimation accuracy, increased throughput performance, and improved OCC efficiency as applied to a frequency selective channels.

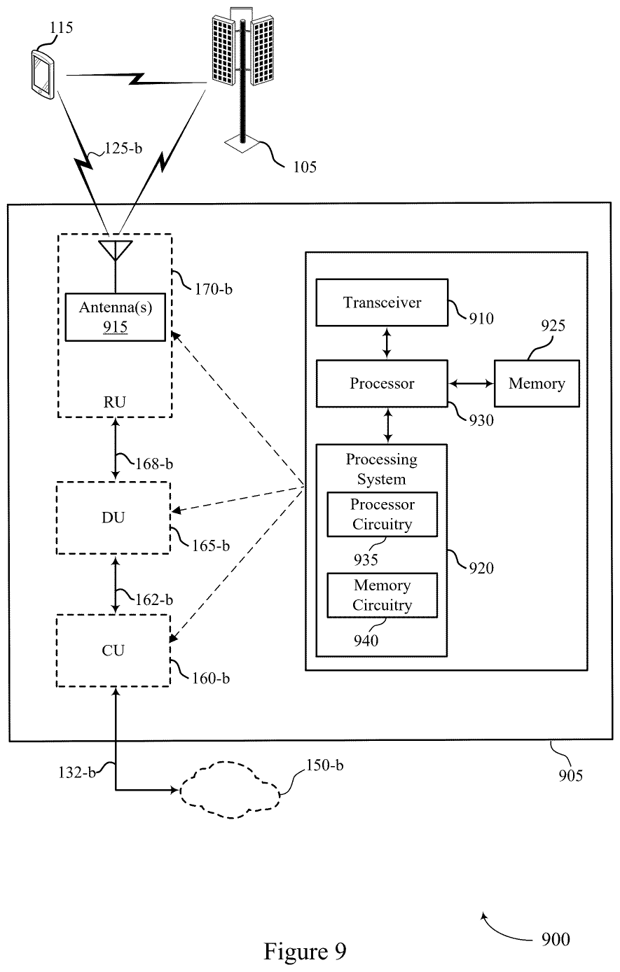

FIG. 9 shows an example of a system 900 including a device 905 that supports channel estimation techniques for mixed length OCCs. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 820. For example, the processing system 920 may include processor circuitry 935 and memory circuitry 940 that stores code, and the processing system 920 may be configured to cause the device 905 to perform operations that support channel estimation techniques for mixed length OCCs. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for improved communication reliability, reduced latency, more efficient utilization of communication resources, improved coordination between devices, improved utilization of processing capability, reduced DMRS overhead, improved channel estimation accuracy, increased throughput performance, and improved OCC efficiency as applied to a frequency selective channels.

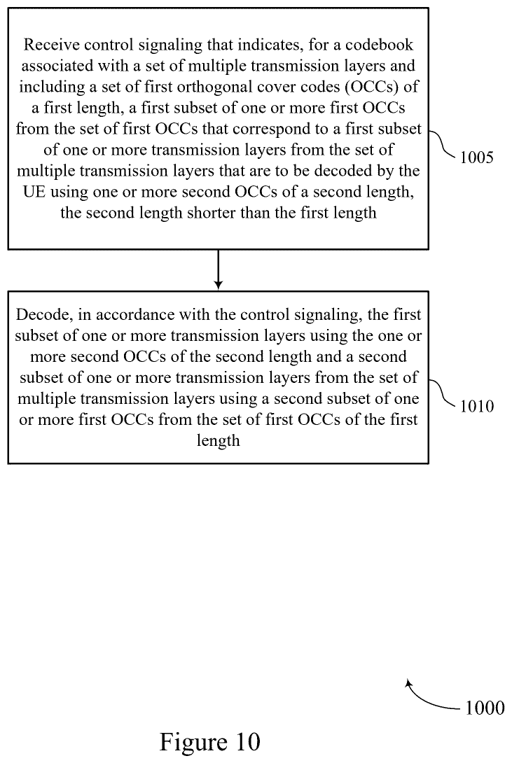

FIG. 10 shows an example of a method 1000 that supports channel estimation techniques for mixed length OCCs. Operations of the method 1000 may be performed by a UE or its components (such as using a processing system configured to cause the UE 115 to perform one or more of the operations) as described herein.

At 1005, the method may include receiving control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded by the UE using one or more second OCCs of a second length, the second length shorter than the first length. In some examples, aspects of the operations of 1005 may be performed by a OCC configuration component 625.

At 1010, the method may include decoding, in accordance with the control signaling, the first subset of one or more transmission layers using the one or more second OCCs of the second length and a second subset of one or more transmission layers from the set of multiple transmission layers using a second subset of one or more first OCCs from the set of first OCCs of the first length. In some examples, aspects of the operations of 1010 may be performed by a de-OCC component 630.

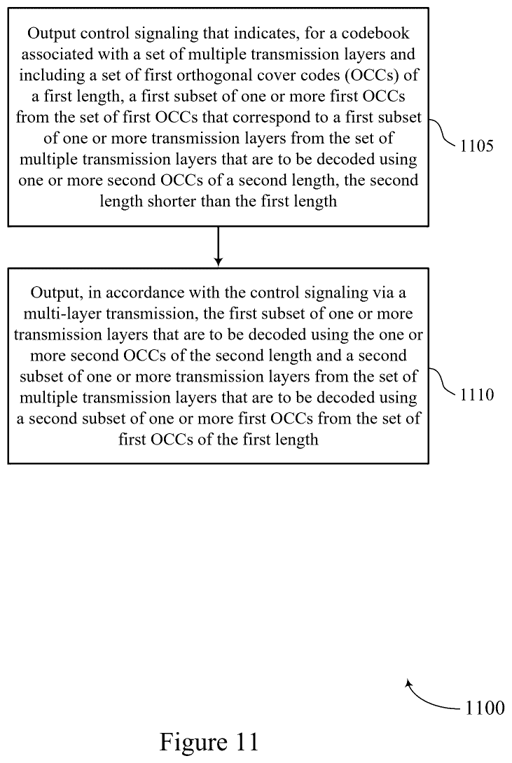

FIG. 11 shows an example of a method 1100 that supports channel estimation techniques for mixed length OCCs. Operations of the method 1100 may be performed by a network entity 105 or its components (such as using a processing system configured to cause the network entity to perform one or more operations) as described herein.

At 1105, the method may include outputting control signaling that indicates, for a codebook associated with a set of multiple transmission layers and including a set of first OCCs of a first length, a first subset of one or more first OCCs from the set of first OCCs that correspond to a first subset of one or more transmission layers from the set of multiple transmission layers that are to be decoded using one or more second OCCs of a second length, the second length shorter than the first length. In some examples, aspects of the operations of 1105 may be performed by a OCC configuration signaling component 825.

At 1110, the method may include outputting, in accordance with the control signaling via a multi-layer transmission, the first subset of one or more transmission layers that are to be decoded using the one or more second OCCs of the second length and a second subset of one or more transmission layers from the set of multiple transmission layers that are to be decoded using a second subset of one or more first OCCs from the set of first OCCs of the first length. In some examples, aspects of the operations of 1110 may be performed by a multi-layer transmission component 830.

Implementation examples are described in the following numbered clauses:
Aspect 1: A method for wireless communications at a UE, comprising: receiving control signaling that indicates, for a codebook associated with a plurality of transmission layers and comprising a set of first OCCs of a first length, a first subset of one or more first OCCs from the set of first OCCs that correspond to a first subset of one or more transmission layers from the plurality of transmission layers that are to be decoded by the UE using one or more second OCCs of a second length, the second length shorter than the first length; and decoding, in accordance with the control signaling, the first subset of one or more transmission layers using the one or more second OCCs of the second length and a second subset of one or more transmission layers from the plurality of transmission layers using a second subset of one or more first OCCs from the set of first OCCs of the first length.
Aspect 2: The method of aspect 1, wherein each of the one or more second OCCs of the second length is orthogonal to each other of the one or more second OCCs of the second length.
Aspect 3: The method of aspect 2, wherein each of the one or more second OCCs of the second length comprises a portion of a respective first OCC from the set of first OCCs of the first length.
Aspect 4: The method of any of aspects 1 through 3, wherein each OCC of the first subset of one or more first OCCs corresponds to a respective transmission layer in the first subset of one or more transmission layers, and each transmission layer in the first subset of one or more transmission layers has a frequency domain correlation that is less than a frequency domain correlation threshold.
Aspect 5: The method of any of aspects 1 through 4, wherein, in accordance with the plurality of transmission layers being assigned to respective OCCs from the set of first OCCs in accordance with respective frequency domain correlations: a first transmission layer having a lowest frequency domain correlation from among the plurality of transmission layers is assigned to a first OCC that is to be decoded using a second OCC of the second length, and a second transmission layer having a highest frequency domain correlation from among the plurality of transmission layers is assigned to a different first OCC that is to be decoded using a first OCC of the first length.
Aspect 6: The method of any of aspects 1 through 5, wherein the plurality of transmission layers comprises four transmission layers and the first subset of one or more transmission layers comprises two transmission layers, and wherein decoding the first subset of one or more transmission layers using the one or more second OCCs comprises: decoding each of the two transmission layers using respective second OCCs from among the one or more second OCCs, wherein a respective second OCC for a first one of the two transmission layers is orthogonal to a respective second OCC for a second one of the two transmission layers.
Aspect 7: The method of any of aspects 1 through 6, wherein the plurality of transmission layers comprises three transmission layers and the first subset of one or more transmission layers comprises a single transmission layer, and wherein decoding the first subset of one or more transmission layers using the one or more second OCCs comprises: decoding the single transmission layer using a second OCC from among the one or more second OCCs.
Aspect 8: The method of any of aspects 1 through 7, wherein the plurality of transmission layers are in accordance with SU-MIMO communications, and wherein receiving the control signaling comprises: receiving one or more RRC messages that configure the first subset of one or more first OCCs that correspond to the first subset of one or more transmission layers that are to be decoded by the UE using the one or more second OCCs of the second length.
Aspect 9: The method of any of aspects 1 through 8, wherein the plurality of transmission layers are in accordance with MU-MIMO communications, and wherein receiving the control signaling comprises: receiving a MAC-CE, DCI, or both, that indicates the first subset of one or more first OCCs that correspond to the first subset of one or more transmission layers that are to be decoded by the UE using the one or more second OCCs of the second length.
Aspect 10: The method of any of aspects 1 through 9, further comprising: performing one or more first channel estimations for the first subset of one or more transmission layers that correspond to the one or more second OCCs of the second length; and performing one or more second channel estimations for the second subset of one or more transmission layers that correspond to the one or more first OCCs of the first length.
Aspect 11: The method of aspect 10, wherein the one or more first channel estimations are performed prior to the one or more second channel estimations, or the one or more first channel estimations are performed subsequent to the one or more second channel estimations.
Aspect 12: The method of any of aspects 10 through 11, wherein the one or more first channel estimations are performed simultaneously for all transmission layers in the first subset of one or more transmission layers or are performed sequentially layer-by-layer for the transmission layers in the first subset of one or more transmission layers, and the one or more second channel estimations are performed simultaneously on all transmission layers in the second subset of one or more transmission layers or are performed sequentially layer-by-layer for the transmission layers in the second subset of one or more transmission layers.
Aspect 13: The method of any of aspects 10 through 12, further comprising: cancelling, prior to performing the one or more second channel estimations, one or more signal components associated with the first subset of one or more transmission layers from a received signal that corresponds to the second subset of one or more transmission layers.
Aspect 14: The method of aspect 13, wherein a DMRS transmit power associated with the first subset of one or more transmission layers is higher than a DMRS transmit power associated with the second subset of one or more transmission layers.
Aspect 15: The method of any of aspects 10 through 14, further comprising: cancelling, prior to performing the one or more first channel estimations, one or more signal components associated with the second subset of one or more transmission layers from a received signal that corresponds the first subset of one or more transmission layers.
Aspect 16: The method of aspect 15, wherein a DMRS transmit power associated with the second subset of one or more transmission layers is higher than to a DMRS transmit power associated with the first subset of one or more transmission layers.
Aspect 17: The method of any of aspects 1 through 16, wherein the plurality of transmission layers comprise a plurality of MIMO communication layers.
Aspect 18: A method for wireless communications at a network entity, comprising: outputting control signaling that indicates, for a codebook associated with a plurality of transmission layers and comprising a set of first OCCs of a first length, a first subset of one or more first OCCs from the set of first OCCs that correspond to a first subset of one or more transmission layers from the plurality of transmission layers that are to be decoded using one or more second OCCs of a second length, the second length shorter than the first length; and outputting, in accordance with the control signaling via a multi-layer transmission, the first subset of one or more transmission layers that are to be decoded using the one or more second OCCs of the second length and a second subset of one or more transmission layers from the plurality of transmission layers that are to be decoded using a second subset of one or more first OCCs from the set of first OCCs of the first length.
Aspect 19: The method of aspect 18, wherein each of the one or more second OCCs of the second length is orthogonal to each other of the one or more second OCCs of the second length.
Aspect 20: The method of aspect 19, wherein each of the one or more second OCCs of the second length comprises a portion of a respective first OCC from the set of first OCCs of the first length.
Aspect 21: The method of any of aspects 18 through 20, wherein each OCC of the first subset of one or more first OCCs corresponds to a respective transmission layer in the first subset of one or more transmission layers, and each transmission layer in the first subset of one or more transmission layers has a frequency domain correlation that is less than a frequency domain correlation threshold.
Aspect 22: The method of any of aspects 18 through 21, wherein, in accordance with the plurality of transmission layers being assigned to respective OCCs from the set of first OCCs in accordance with respective frequency domain correlations: a first transmission layer having a lowest frequency domain correlation from among the plurality of transmission layers is assigned to a first OCC that is to be decoded using a second OCC of the second length, and a second transmission layer having a highest frequency domain correlation from among the plurality of transmission layers is assigned to a different first OCC that is to be decoded using a first OCC of the first length.
Aspect 23: The method of any of aspects 18 through 22, wherein the plurality of transmission layers comprises four transmission layers and the first subset of one or more transmission layers comprises two transmission layers, wherein each of the two transmission layers are to be decoded using respective second OCCs from among the one or more second OCCs, and wherein a respective second OCC for a first one of the two transmission layers is orthogonal to a respective second OCC for a second one of the two transmission layers.
Aspect 24: The method of any of aspects 18 through 23, wherein the plurality of transmission layers comprises three transmission layers and the first subset of one or more transmission layers comprises a single transmission layer, and wherein the single transmission layer is to be decoded using a second OCC from among the one or more second OCCs.
Aspect 25: The method of any of aspects 18 through 24, wherein the plurality of transmission layers are in accordance with single-user multiple-input multiple-output (SU-MIMO) communications, and wherein outputting the control signaling comprises: outputting one or more RRC messages that configure the first subset of one or more first OCCs that correspond to the first subset of one or more transmission layers that are to be decoded using the one or more second OCCs of the second length.
Aspect 26: The method of any of aspects 18 through 25, wherein the plurality of transmission layers are in accordance with multi-user multiple-input multiple-output (MU-MIMO) communications, and wherein outputting the control signaling comprises: outputting a MAC-CE, DCI, or both, that indicates the first subset of one or more first OCCs that correspond to the first subset of one or more transmission layers that are to be decoded using the one or more second OCCs of the second length.
Aspect 27: The method of any of aspects 18 through 26, wherein the plurality of transmission layers comprise a plurality of MIMO communication layers.
Aspect 28: A UE for wireless communications, comprising a processing system that includes processor circuitry and memory circuitry that stores code, the processing system configured to cause the UE to perform a method of any of aspects 1 through 17.
Aspect 29: A UE for wireless communications, comprising at least one means for performing a method of any of aspects 1 through 17.
Aspect 30: A non-transitory computer-readable medium storing code for wireless communications, the code comprising instructions executable by one or more processors to perform a method of any of aspects 1 through 17.
Aspect 31: A network entity for wireless communications, comprising a processing system that includes processor circuitry and memory circuitry that stores code, the processing system configured to cause the network entity to perform a method of any of aspects 18 through 27.
Aspect 32: A network entity for wireless communications, comprising at least one means for performing a method of any of aspects 18 through 27.
Aspect 33: A non-transitory computer-readable medium storing code for wireless communications, the code comprising instructions executable by one or more processors to perform a method of any of aspects 18 through 27.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling that indicates, for a codebook associated with a plurality of transmission layers and comprising a set of first orthogonal cover codes (OCCs) of a first length, a first subset of one or more first OCCs from the set of first OCCs that correspond to a first subset of one or more transmission layers from the plurality of transmission layers that are to be decoded by the UE using one or more second OCCs of a second length, the second length shorter than the first length; and
decode, in accordance with the control signaling, the first subset of one or more transmission layers using the one or more second OCCs of the second length and a second subset of one or more transmission layers from the plurality of transmission layers using a second subset of one or more first OCCs from the set of first OCCs of the first length.

2. The UE of claim 1, wherein each of the one or more second OCCs of the second length is orthogonal to each other of the one or more second OCCs of the second length.

3. The UE of claim 2, wherein each of the one or more second OCCs of the second length comprises a portion of a respective first OCC from the set of first OCCs of the first length.

4. The UE of claim 1, wherein:
each OCC of the first subset of one or more first OCCs corresponds to a respective transmission layer in the first subset of one or more transmission layers, and
each transmission layer in the first subset of one or more transmission layers has a frequency domain correlation that is less than a frequency domain correlation threshold.

5. The UE of claim 1, wherein in accordance with the plurality of transmission layers being assigned to respective OCCs from the set of first OCCs in accordance with respective frequency domain correlations:
a first transmission layer having a lowest frequency domain correlation from among the plurality of transmission layers is assigned to a first OCC that is to be decoded using a second OCC of the second length, and
a second transmission layer having a highest frequency domain correlation from among the plurality of transmission layers is assigned to a different first OCC that is to be decoded using a first OCC of the first length.

6. The UE of claim 1, wherein the plurality of transmission layers comprises four transmission layers and the first subset of one or more transmission layers comprises two transmission layers, and wherein, to decode the first subset of one or more transmission layers using the one or more second OCCs, the processing system is configured to cause the UE to:
decode each of the two transmission layers using respective second OCCs from among the one or more second OCCs, wherein a respective second OCC for a first one of the two transmission layers is orthogonal to a respective second OCC for a second one of the two transmission layers.

7. The UE of claim 1, wherein the plurality of transmission layers comprises three transmission layers and the first subset of one or more transmission layers comprises a single transmission layer, and wherein, to decode the first subset of one or more transmission layers using the one or more second OCCs, the processing system is configured to cause the UE to:
decode the single transmission layer using a second OCC from among the one or more second OCCs.

8. The UE of claim 1, wherein the plurality of transmission layers are in accordance with single-user multiple-input multiple-output (SU-MIMO) communications, and wherein, to receive the control signaling, the processing system is configured to cause the UE to:
receive one or more radio resource control (RRC) messages that configure the first subset of one or more first OCCs that correspond to the first subset of one or more transmission layers that are to be decoded by the UE using the one or more second OCCs of the second length.

9. The UE of claim 1, wherein the plurality of transmission layers are in accordance with multi-user multiple-input multiple-output (MU-MIMO) communications, and wherein, to receive the control signaling, the processing system is configured to cause the UE to:
receive a medium access control-control element (MAC-CE), downlink control information (DCI), or both, that indicates the first subset of one or more first OCCs that correspond to the first subset of one or more transmission layers that are to be decoded by the UE using the one or more second OCCs of the second length.

10. The UE of claim 1, wherein the processing system is further configured to cause the UE to:
perform one or more first channel estimations for the first subset of one or more transmission layers that correspond to the one or more second OCCs of the second length; and
perform one or more second channel estimations for the second subset of one or more transmission layers that correspond to the set of first OCCs of the first length.

11. The UE of claim 10, wherein the one or more first channel estimations are performed prior to the one or more second channel estimations, or the one or more first channel estimations are performed subsequent to the one or more second channel estimations.

12. The UE of claim 10, wherein:
the one or more first channel estimations are performed simultaneously for all transmission layers in the first subset of one or more transmission layers or are performed sequentially layer-by-layer for the transmission layers in the first subset of one or more transmission layers, and
the one or more second channel estimations are performed simultaneously on all transmission layers in the second subset of one or more transmission layers or are performed sequentially layer-by-layer for the transmission layers in the second subset of one or more transmission layers.

13. The UE of claim 10, wherein the processing system is further configured to cause the UE to:
cancel, prior to performing the one or more second channel estimations, one or more signal components associated with the first subset of one or more transmission layers from a received signal that corresponds to the second subset of one or more transmission layers.

14. The UE of claim 13, wherein a demodulation reference signal (DMRS) transmit power associated with the first subset of one or more transmission layers is higher than a DMRS transmit power associated with the second subset of one or more transmission layers.

15. The UE of claim 10, wherein the processing system is further configured to cause the UE to:
cancel, prior to performing the one or more first channel estimations, one or more signal components associated with the second subset of one or more transmission layers from a received signal that corresponds the first subset of one or more transmission layers.

16. The UE of claim 15, wherein a demodulation reference signal (DMRS) transmit power associated with the second subset of one or more transmission layers is higher than to a DMRS transmit power associated with the first subset of one or more transmission layers.

17. The UE of claim 1, wherein the plurality of transmission layers comprise a plurality of multiple-input multiple-output (MIMO) communication layers.

18. A network entity, comprising:
a processing system that includes processor circuitry and memory circuitry that stores code, the processing system configured to cause the network entity to:
output control signaling that indicates, for a codebook associated with a plurality of transmission layers and comprising a set of first orthogonal cover codes (OCCs) of a first length, a first subset of one or more first OCCs from the set of first OCCs that correspond to a first subset of one or more transmission layers from the plurality of transmission layers that are to be decoded using one or more second OCCs of a second length, the second length shorter than the first length; and
output, in accordance with the control signaling via a multi-layer transmission, the first subset of one or more transmission layers that are to be decoded using the one or more second OCCs of the second length and a second subset of one or more transmission layers from the plurality of transmission layers that are to be decoded using a second subset of one or more first OCCs from the set of first OCCs of the first length.

19. The network entity of claim 18, wherein:
each OCC of the first subset of one or more first OCCs corresponds to a respective transmission layer in the first subset of one or more transmission layers, and
each transmission layer in the first subset of one or more transmission layers has a frequency domain correlation that is less than a frequency domain correlation threshold.

20. A method for wireless communications at a user equipment (UE), comprising:
receiving control signaling that indicates, for a codebook associated with a plurality of transmission layers and comprising a set of first orthogonal cover codes (OCCs) of a first length, a first subset of one or more first OCCs from the set of first OCCs that correspond to a first subset of one or more transmission layers from the plurality of transmission layers that are to be decoded by the UE using one or more second OCCs of a second length, the second length shorter than the first length; and
decoding, in accordance with the control signaling, the first subset of one or more transmission layers using the one or more second OCCs of the second length and a second subset of one or more transmission layers from the plurality of transmission layers using a second subset of one or more first OCCs from the set of first OCCs of the first length.
